(19) United States
(12) Patent Application Publication
(10) Pub. No.: US 2003/0055211 A1
(43) Pub. Date: Mar. 20, 2003

(54) Chitosan condensation products, their preparation and their uses

(76) Inventor: George Andrew Francis Roberts, Nottinghamshire (GB)

Correspondence Address: Nixon & Vanderhye, 1100 North Glebe Road 8th Floor, Arlington, VA, 22201-4714, US

(21) Appl. No.: 10/169,145

(22) PCT Filed: Jan. 25, 2001
(86) PCT No.: PCT/GB01/00289

(30) Foreign Application Priority Data
Jan. 27, 2000 (GB) 0001734.3

(51) Int. Cl. C08B 37/08; C08G 75/18

(52) U.S. Cl. 528/391; 536/20

(57) ABSTRACT

A condensation product of chitosan is formed by its reaction with a bisulfite addition compound HOCRR′SO₃A wherein: each of R and R′ independently represents a hydrogen atom, or R represents a hydrogen atom and R′ represents an optionally substituted linear or branched saturated or unsaturated hydrocarbon group having up to 10 carbon atoms or an optionally substituted alicyclic, aromatic carbocyclic or heterocyclic ring, or R represents a CH₃ group and R′ represents an optionally substituted primary alkyl group, or R and R′ together represent an optionally substituted alicyclic or heterocyclic ring, and A represents an alkali metal or ammonium ion. The condensation product/polymer is an anionic polyelectrolyte and forms stable anionic solutions in water at neutral pH. Such solutions may be mixed with other water soluble anionic polyelectrolyte, especially sodium alginate, to form very intimate admixtures or blends from which films, fibers, powders, sponges, gels and foams may be prepared. The chitosan may be regenerated from the condensation product in those films, fibers, powders, sponges, gels and foams by acid or alkali treatment during or subsequent to their production. The solubility of the condensation product also opens the way to a novel method for the extraction of chitosan from chitin/calcium carbonate mixtures.

### TECHNICAL FIELD

The invention relates to a condensation product of chitosan formed by its reaction with a bisulfite addition compound, which condensation product forms a stable anionic polyelectrolyte solution in water at neutral pH. Such solutions may be mixed with other water soluble anionic polyelectrolytes, such as sodium alginate or hyaluronic acid, to form very intimate admixtures or blends from which films, fibres, powders, sponges, gels and foams may be prepared. The chitosan may be regenerated from the condensation product in those films, fibres, powders, sponges, gels and foams by acid or alkali treatment during or subsequent to their production. The solubility of the condensation product also opens the way to a novel method for the extraction of chitosan from chitin/calcium carbonate mixtures.

### BACKGROUND OF THE INVENTION

Chitosan can be obtained on a commercial scale by deacetylation of the biopolymer chitin in concentrated alkaline solutions at elevated temperatures. Chitin is the main structural polymer in the exoskeletons of crustacea, molluscs and insects and is the principal fibrillar polymer in the cell wall of certain fungi and actinomycetes. The names “chitin” and “chitosan” do not refer to materials having discrete chemical structures but to a continuum of co-polymers of N-acetyl-D-glucosamine residues (K) and D-glucosamine residues (L):

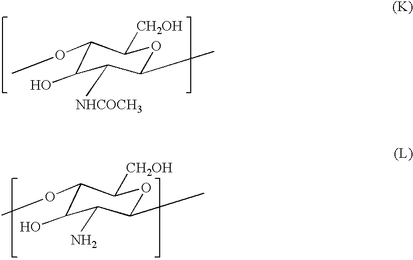

The two materials may be distinguished by their solubility (chitosan) or insolubility (chitin) in dilute aqueous acid solutions. Chitosan, being a base, forms a salt with acids so producing cationic polyelectrolyte structures whose solubility in water will depend on the nature of the acid anion involved. Chitosan is soluble in dilute HCl, HBr, HI, HNO₃ and HClO₄ but may be precipitated out of solution in HBr or HCl by increasing the concentration of acid in the system. Chitosan is slightly soluble in dilute H₃PO₄ but is insoluble in dilute H₂SO₄ at room temperature, although chitosan sulfate is soluble in hot water. Chitosan is also soluble in aqueous solutions of a large number of organic acids. However, chitosan is readily hydrolysed on standing in acid and consequently such solutions have limited shelf lives.

The primary source material for chitin/chitosan extraction are crustacean exoskeletons (available as processing waste from the seafood industry). Current commercial extraction processes include a demineralization treatment with hydrochloric acid to remove the calcium carbonate, also present in substantial quantities in the source material. This demineralization generates high volumes of calcium chloride effluent which must be disposed of in an environmentally safe manner.

Chitosan derivatives have been used as chelating agents for collection of chromium(III) ions. Thus Chemical Specification and Bioavailability, 3(2) 1999 55-59 (López-de-Alba et al) discloses chitosan sulfite and bisulfite for this purpose. The latter would appear to be of formula:

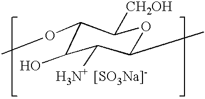

U.S. Pat. No. 4,125,708 (Masri et al./The United States of America as represented by the Secretary of Agriculture) discloses chitosan modified with an anionic agent and glutaraldehyde. The resulting composition would again appear to contain a simple salt or salts of chitosan.

Although chitosan may be regenerated during the chelating processes (see for example the scheme on the last page of López-de-Alba et al.), there is no suggestion that this would ever be used as a method for preparing pure chitosan.

U.S. Pat. No. 4,786,720 (Schilling/Westvaco Corporation) discloses the basic reaction of an amine with sodium formaldehyde bisulfite to make a water-soluble compound.

### SUMMARY OF THE INVENTION

The invention provides a condensation product of chitosan and a bisulfite addition compound which has the formula HOCRR′SO₃A wherein:

each of R and R′ independently represents a hydrogen atom, or R represents a hydrogen atom and R′ represents an optionally substituted linear or branched saturated or unsaturated hydrocarbon group having up to 10 carbon atoms or an optionally substituted alicyclic, aromatic carbocyclic or heterocyclic ring, or R represents a CH₃ group and R′ represents an optionally substituted primary alkyl group, or R and R′ together represent an optionally substituted alicyclic or heterocyclic ring, and

A represents an alkali metal or ammonium ion,

which condensation product forms a stable anionic polyelectrolyte solution in water at neutral pH.

A may represent any alkali metal cation, especially lithium, sodium or potassium, or an ammonium ion. Preferably A represents a sodium ion. R and R′ preferably represent hydrogen atoms. Where R and R′ represent others from the moieties listed above, the preferred optional substituents are carboxy (COOH) and sulfo (SO₃H) groups as their salts.

It will be appreciated that the pH of distilled water may deviate from the standardized neutral value of 7. In this Specification the term ‘neutral pH’ is indicative of a value range of from 5 to 9.

Like chitosan itself, the condensation product of the invention does not have a discrete chemical structure. Rather, it is a continuum of mono-substituted D-glucosamine residues (M) and di-substituted D-glucosamine residues (N):

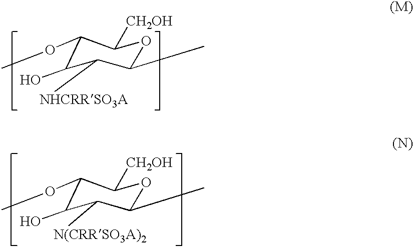

and may include a proportion of residual N-acetyl-D-glucosamine units (K) and D-glucosamine units (L). The relative proportions of these units (K) to (N) depend upon the degree of deacetylation of the chitosan used to prepare the condensation product, the amount of the bisulfite addition compound reacted with the chitosan and the reaction conditions. The condensation product is distinguished from chitosan by its ability to form a stable anionic polyelectrolyte solution in water at neutral pH.

The invention also provides a polymer comprising monomer units of formulae K, L, M and N (as hereinbefore defined) in proportions k, l, m and n respectively such that:

$$\frac{m + 2 n}{k + l + m + n} \times 100 \% \geq 25 \%$$

The above ratio implies a polymer produced by a method in which the number of HOCRR′SO₃A molecules reacting with the chitosan is equal to or greater than 25% of the sugar residues. This ratio may be as high as 200% for a fully deacetylated chitosan in which all the glucosamine residues are saturated with bisulfite moieties. In this case k, l and m are all equal to zero. However, we prefer to have a polymer in which:

$$40 \% \leq \frac{m + 2 n}{k + l + m + n} \times 100 \% \leq 70 \%$$

Especially preferred is a polymer in which:

$$45 \% \leq \frac{m + 2 n}{k + l + m + n} \times 100 \% \leq 50 \%$$

The composition of the polymer can also be expressed in terms of the percentage of sugar residues are derivatized with one or more bisulfite moieties. Thus a preferred polymer is one in which:

$$25 \% \leq \frac{m + n}{k + l + m + n} \times 100 \% \leq 100 \%$$

Especially preferred is a polymer in which:

$$65 \% \leq \frac{m + n}{k + l + m + n} \times 100 \% \leq 95 \%$$

Polymers in this region have been found to give particularly soluble condensation products.

A polymer prepared from a material having 55% or greater deacetylation may be used, to give a soluble product. In other words, 45% is the highest level of residual —NHCOCH3 units that is preferable in a heterogeneously prepared material. Thus one suitable polymer is that in which:

$$\frac{k}{k + l + m + n} \times 100 \% \leq 45 \%$$

The condensation product or polymer of the invention may be prepared by slurrying chitosan with either a solution of the bisulfite addition compound or with a solution containing precursors of the bisulfite addition compound. The amount of bisulfite addition compound required for a given weight of chitosan depends on the molecular weight of the chitosan and its physical structure. The lower the molecular weight of the chitosan, the lower the ratio required to achieve solubility. The more accessible the chitosan, e.g. if it has been dissolved up in dilute acid and then reprecipitated out by making the solution alkaline, the lower the ratio required. As a guide, however, it can be said that from 0.5 to 3.5, more preferably from 1 to 2, moles of the bisulfite addition compound are used per equivalent of chitosan amine groups. These processes are within the scope of the invention.

By “precursors of the bisulfite addition compound” is meant a mixture which can be used to generate the bisulfite addition compound HOCRR′SO₃A in situ. Typically, when A is an alkali metal, this will be a solution of the aldehyde or ketone RR′CO and the appropriate metabisulfite, A₂S₂O₅. For example, a slurry comprising a 30% solution of formaldehyde and Na₂S₂O₅ (sodium metabisulfite) may be used as precursors of sodium formaldehyde bisulfite.

The condensation product or polymer may be precipitated from the preparative reaction mixture by admixture with a water miscible organic solvent, e.g. acetone (the solvent being added to the reaction mixture, or the reaction mixture being added to the solvent). The precipitate can be collected and dried, suitably at 60° C. under vacuum. The isolated condensation product (polymer) is stable and is convenient for transportation and storage. It may be re-dissolved in water at neutral pH, forming solutions having high concentration (up to 15% by weight). Such solutions remain stable for extended periods, certainly exceeding 12 months. The isolated condensation product (polymer) and its aqueous solutions also form a part of the invention.

The polymers where l and n are all equal to zero are particularly simple to make by this route.

The condensation product or polymer may also be prepared conveniently by treating chitosan in solid form with a solution of an alkali metal aldehyde bisulfite, such as sodium formaldehyde bisulfite, in a water/water-miscible organic solvent mixture in which the condensation product, once formed, is not soluble. The product may then be easily filtered off, rinsed and dried to give the condensation product in the form of a stable solid that may be readily dissolved in water at neutral pH.

We have found that homogeneous re-N-acetylation of a sample of chitosan previously deacetylated heterogeneously gives a particularly suitable starting material for formation of a soluble condensation product. An N-acetylation level of up to 75% may be obtained using such a homogeneously prepared sample of chitosan and still give a soluble final product. It would be expected that samples prepared by homogeneous deacetylation of chitin would begin to show solubility on treatment with HOCRR′SO₃Na at about 25% deacetylation, compared to the 55% deacetylation requirement for a heterogeneously prepared sample.

Thus the invention also includes a method for the preparation of a condensation product comprising:

re-acetylation of chitosan comprising monomer units of formulae K and L, in the proportions k and l, respectively, to give material wherein k/(k+l) is less than or equal to 75%, and

reacting with a solution containing a bisulfite addition compound, or its precursors, as defined above.

By this method may be made a polymer in which:

$$\frac{k}{k + l + m + n} \times 100 \% \leq 75 \%$$

and which is a suitable starting material for the preparation of a bisulfite condensation product soluble in water at neutral pH.

Alternative routes that may be used to produce the chitosan condensation product Chit—NH—CH₂SO₃Na utilize techniques that are analogous to reactions that are used to produce the carboxylic acid equivalent, namely Chit—NH—CH₂COONa:

Chit—NH₂+Cl—CH₂SO₃Na+NaOH→Chit—NH—CH₂SO₃Na

Chit—NH₂+O═CH—SO₃Na+NaBH₄→Chit—NH—CH₂SO₃Na

The solutions according to the invention may be mixed with other water soluble anionic polyelectrolytes, both natural and man-made. Examples of these are sodium alginate, sodium carboxyrnethylcellulose, carragheenan, sodium cellulose sulfate, chondroitin sulfates, dermatan sulfate, heparan sulfate, heparin, hyaluronic acid, keratan sulfate, pectin, poly(sodium acrylate) and poly(sodium methacrylate). The solutions may also be mixed with water soluble proteins such as collagen and gelatine. The resultant mixed solutions, which also form part of the invention, are themselves stable. The preferred ratio of condensation product or polymer to other water soluble anionic polyelectrolytes is from 5:1 to 1:5 by weight, although any other ratio of combination required may be readily obtained. The preferred other water soluble anionic polyelectrolyte is sodium alginate.

Mixtures of chitosan and alginate (a water soluble anionic polyelectrolyte) have been disclosed previously, e.g. U.S. Pat. No. 5,836,970 (Pandit/The Kendall Company) and WO 99/01166 (Coloplast A/S). However both of these approaches use chitosan in the form of a cationic polyelectrolyte, in which form it interacts rapidly with the anionic alginate to give an insoluble polyelectrolyte complex. Thus the products obtained following these references consist of heterogeneous mixtures of the two components in which there is either no continuous phase or one of the components forms the continuous phase with the second component present in the form of particles suspended in this continuous phase. A layer of polyelectrolyte complex is formed at each of the interfaces between the two components. The particle size depends on the severity of the mixing treatment, while which component forms the continuous phase depends, inter alia, on the relative proportions of each and their molecular weight.

This contrasts with the blended solutions according to the invention since in these both components are present in the continuous phase in the form of a homogeneous blend, intimately mixed at the molecular level. Films cast from chitosan/alginate mixtures using the process of the invention are clear and visually uniform whereas those cast using the processes described in U.S. Pat. No. 5,836,970 have a mosaic-like appearance . The difference in appearance, which is clearly discernible with the naked eye, is due to the non-uniform structure of the latter films which are composed of “islands” of one component embedded in the second component and with a polyclectrolyte complex membrane at the interfaces between the “islands” and the matrix.

The mixed solutions can be used in conventional methods for the preparation of films, fibres, powders, sponges, foams and gels which themselves contain chitosan (as the condensation product or as itself, see below) and alginate (or other water soluble anionic polyelectrolytes) in the continuous phase in the form of a homogeneous blend, intimately mixed at the molecular level. The difference in structures may be clearly seen with the naked eye in films made by the different methods, and may also be objectively demonstrated by various scientific techniques. Owing to the homogeneous nature of the blends produced according to the invention, films and fibres produced from them have greater mechanical strength and flexibility, together with greater optical clarity.

It should be noted that films, fibres, powders, sponges, foams and gels can also be prepared from the solutions according to the invention unmixed with any other substances; such films, fibres, powders, sponges, foams and gels contain only chitosan (as the condensation product or as itself, see below).

Treatment of the condensation product of the invention with an acid or an alkali enables the chitosan to be regenerated. This is the case even when the condensation product has been formed into films, fibres, powders, sponges, foams and gels as described above. Indeed the regeneration treatment can be effected on the films, fibres, powders, sponges, foams and gels during their preparation or subsequent thereto.

Another route for producing bio-polymer blends such as chitosan/alginate or other chitosan/anionic polyelectrolyte blends uses viscose rayon technology to produce chitosan xanthate, which is anionic and hence does not form a polyelectrolyte complex when mixed with another anionic polyelectrolyte. The chitosan can be regenerated from the chitosan xanthate by treatment with acid.

In a preferred embodiment the invention also provides a method for preparing a polymer blend, the method comprising the steps of:

blending an aqueous solution as above defined with alginate in a weight ratio within the range of 5:1 to 1:5

treating the polymer blend so produced with an acid or alkali so as to regenerate chitosan or its salt.

The solubility of the condensation product of the invention in water at neutral pH also allows chitosan to be extracted from a chitin/calcium carbonate mixture, for example crustacean exoskeleton processing waste from the seafood industry. The extraction method comprises deacetylating the chitin in the said chitin/calcium carbonate mixture, slurrying the resultant chitosan/calcium carbonate mixture with a solution containing a sodium bisulfite addition compound as defined above or the precursors of such an addition compound and removing undissolved solids from the solution. The solution can be admixed with a water miscible organic solvent to precipitate the chitosan condensation product, which can be collected, washed and dried. Alternatively the pH of the solution can be raised to reconstitute the chitosan and precipitate it, after which it may be collected, washed with water and dried. These processes, which are within the scope of the invention, avoid the production of calcium chloride effluent.

The wide range of possible physical forms makes available a wide range of uses for the chitosan products of the invention, especially biomedical uses. These include wound and burn dressings, pharmaceutical excipients, transdermal controlled release drug patches, sutures and coatings therefor, adjuvants for calcium phosphate bone cements, scaffold materials for tissue engineering applications, medical device materials or coatings for conventional medical devices, surgical adhesion barriers, periodontal disease treatment, and the sealing of arterial puncture sites after catheterization. Other potential non-medical applications are found in the food and beverage industry, e.g. as preservatives, stabilizers and hydration control coatings, in the preparation of cosmetics and toiletries, in agriculture as a seed treatment and as a pesticide and in water treatment, particularly for heavy metal ion extraction, and as membranes for use in separation processes.

### DETAILED DESCRIPTION OF THE INVENTION

The invention is illustrated by the following Examples.

### EXAMPLE 1

Preparation of a Chitosan Condensation Product

2 g of a high molecular weight (4.3×10⁵) chitosan produced from prawn shell and having a level of deacetylation of approximately 72%, was slurried at room temperature with magnetic stirring in 100 ml of distilled water containing 2 g of HOCH₂SO₃Na (sodium formaldehyde bisulfite) to give a 1.8:1 ratio of moles of sodium formaldehyde bisulfite:equivalents of amine groups. The chitosan dissolved over a period of 3 to 4 hours to yield a clear smooth-flowing solution.

### EXAMPLE 2

Preparation of a Chitosan Condensation Product

2 g of chitosan, similar to that used in Example 1, was slurried at room temperature with magnetic stirring in 100 ml of distilled water containing 2 ml of a 30% solution of formaldehyde and 2.1 g of Na₂S₂O₅ (sodium metabisulfite) as precursors of sodium formaldehyde bisulfite to give a 2.4:1 ratio of moles of sodium formaldehyde bisulfite: equivalents of amine groups. The chitosan dissolved over a period of 3 to 4 hours to yield a clear smooth-flowing solution.

### EXAMPLE 2A

Preparation of a Chitosan Condensation Product

6.5 g of chitosan, similar to that used in Examples 1 and 2, was slurried for 4 hours at 25° C. in 80% methanol containing 12.6 g HOCH₂SO₃Na. The solid was filtered off, rinsed in 80% methanol to remove unreacted HOCH₂SO₃Na, rinsed again in methanol and then dried under vacuum at 60° C. to give 10.5 g of a fine white powder that was readily soluble in water at neutral pH.

### EXAMPLE 3

Preparation of Chitosan/Sodium Alginate and Chitosan/Carragheenan Films

2 g of reprecipitated chitosan, prepared by addition of concentrated NH₄OH to a solution of the chitosan in 1% aqueous acid and having 82% deacetylation and a molecular weight of 8.2×10⁴, was slurried at room temperature in 100 ml of distilled water containing 2 g of HOCH₂SO₃Na, giving a 1.5:1 ratio of moles of sodium formaldehyde bisulfite: equivalents of amine groups solution. Separate aliquots (10 ml) of the resultant solution were then mixed with 10 ml of a 2% (w/v) aqueous solution of sodium alginate and 10 ml of a 2% (w/v) aqueous solution of carragheenan respectively. In the case of the chitosan condensation product/carragheenan blended solution, mixing was carried out at 40° C. to ensure that the carragheenan solution was above its gelation temperature Films were cast from the blended solutions and air-dried. The films were then steeped in 80% aqueous ethanol containing 0.5% Na₂CO₃ to regenerate the chitosan, washed in 80% aqueous ethanol and dried to give tough, flexible blend films having a transparency similar to that of films cast from the individual polymer solutions.

### EXAMPLE 4

Preparation of Chitosan/Sodium Alginate and Chitosan/Carragheenan Films

Example 3 was repeated using 2 g of the reprecipitated chitosan and the solution process described in Example 2. After regenerating the chitosan the blend films had physical characteristics similar to those of the films prepared in Example 3.

### EXAMPLE 5

Isolation of the Chitosan Condensation Product as a Solid

A solution of chitosan, prepared as described in Example 3, was poured into acetone to precipitate the chitosan condensation product. This was collected, washed with 70% aqueous ethanol and then dried at 60° C. under vacuum. The isolated chitosan condensation product has been stored in sealed containers at room temperature for periods of up to 15 months. All stored samples remained readily soluble in water throughout the storage period. Solutions prepared from the isolated chitosan condensation product have also been stored at room temperature for periods for periods of up to 15 months and were not affected by microbial contamination.

### EXAMPLE 6

Isolation of the Chitosan Condensation Product as a Solid

A solution of chitosan, prepared as described in Example 4, was poured into acetone to precipitate the chitosan condensation product. The precipitate was collected, dried and washed as described in Example 5 to obtain an isolated chitosan condensation product indistinguishable from that prepared in Example 5.

### EXAMPLE 7

Preparation of Chitosan Condensation Product/Sodium Alginate and Chitosan Condensation Product/Carragheenan Films

2 g of the reprecipitated chitosan sample prepared in Example 3 was slurried for 2 hours in 70% aqueous ethanol containing 2 g of HOCH₂SO₃Na, then rinsed with further 70% aqueous ethanol and dried. Two portions (0.3 g each) of the dried chitosan condensation product were dissolved in 10 ml aliquots of distilled water and mixed, separately, with 10 ml of a 2% (w/v) aqueous solution of sodium alginate and 10 ml of a 2% (w/v) aqueous solution of carragheenan. In the case of the chitosan condensation product/carragheenan blended solution, mixing was carried out at 40° C. to ensure that the carragheenan solution was above its gelation temperature. Films were cast from the blended solutions and air-dried. The films produced were tough, flexible and transparent.

### EXAMPLE 8

Preparation of Chitosan Condensation Product/Sodium Alginate and Chitosan Condensation Product/Carragheenan Films

Example 7 was repeated, but using 70% aqueous ethanol containing 2 ml of a 30% formaldehyde solution and 2.1 g of Na₂S₂O₅ (sodium metabisulfite) as precursors of the HOCH₂SO₃Na. The blend films had physical characteristics similar to those of the films prepared in Example 7.

### EXAMPLE 9

Preparation of Chitosan/Sodium Alginate/Sodium Carboxymethylcellulose Films

4 g of a chitosan condensation product, prepared as described in Example 5, was dissolved in 100 ml of distilled water. A 10 ml aliquot of the solution was mixed with a 10 ml aliquot of a solution containing 2% (w/v) sodium carboxymethylcellulose and 2% (w/v) sodium alginate, and films were cast from the mixed solution. The dried films were steeped in 80% aqueous ethanol containing 0.5% NaOH to regenerate the chitosan, washed in 80% aqueous ethanol to neutral and dried to give tough, flexible and transparent blend films.

### EXAMPLE 10

Preparation of Chitosan/Sodium Alginate Fibres

A solution containing 10 g of a chitosan condensation product, prepared as described in Example 5, in 100 ml of distilled water was mixed with an equal volume of a solution containing 10 g of sodium alginate in 100 ml of distilled water. The concentrated solution was extruded through a fine nozzle into a bath of 10% aqueous CaCl₂ solution. The filaments formed were washed with distilled water, treated with 2% aqueous NaOH solution, rinsed in 50% aqueous ethanol and dried to give a strong, fibrous product.

### EXAMPLE 11

Preparation of a Spongy Mat of Chitosan/Sodium Alginate

A solution containing 2% (w/v) of a chitosan condensation product, prepared as described in Example 5, and 2% (w/v) sodium alginate was subjected to freezing followed by removal of the water by sublimation (“freeze drying”) to give an intimately mixed polymer blend in the form of a spongy mat. Treatment of the mat with 0.5% NaOH followed by rinsing in 50% aqueous ethanol converted the mat to one of chitosan/sodium alginate without loss of its physical structure.

### EXAMPLE 12

Preparation of Chitosan/Sodium Alginate Blend

10 g of reprecipitated chitosan having 82% deacetylation and a molecular weight of 5.3×10⁴ was steeped for 2 hours in excess 30% (wt/wt) NaOH and the surplus alkali removed by pressing to give 37.5 g of alkali chitosan. After shredding the alkali chitosan it was mixed in a sealed vessel with 20 ml CS₂ and allowed to stand for 18 hours at room temperature. The orange sodium chitosan xanthate was then dissolved in water containing the minimum amount of NaOH to give a 4% (wt/vol) solution of sodium chitosan xanthate. A 25 ml aliquot of this solution was mixed with 25 ml of a 2% (wt/vol) solution of sodium alginate in water and a film cast from the mixture. After air-drying the film was steeped in 75% aqueous ethanol containing 4% H₂SO₄, then in 75% aqueous ethanol containing 1% Na₂CO₃, rinsed in 75% aqueous ethanol and air dried to give a homogeneous chitosan/sodium alginate blend in the form of a tough, flexible, transparent film.

### EXAMPLE 13

Preparation of a Chitosan Condensation Product with Potassium Formaldehyde Bisulfite.

2 g of a micro-crystalline chitosan having 92% deacetylation and a molecular weight of 1.5×10⁵ was slurried at 25° C. in 100 ml of distilled water containing 3 g HOCH₂SO₃K (potassium formaldehyde bisulfite) to give a 1.8:1 ratio (approx.) of moles of potassium formaldehyde bisulfite:equivalents of amine groups. The chitosan gradually dissolved over a period of 5-6 hours to yield a clear smooth-flowing solution.

### EXAMPLE 14

Preparation of a Chitosan Condensation Product with Sodium Acetone Bisulfite.

2 g of a micro-crystalline chitosan having 92% deacetylation and a molecular weight of 1.5×10⁵ was slurried at 25° C. in 100 ml of distilled water containing 3.25 g HOC(CH₃)₂SO₃Na (sodium acetone bisulfite) to give a 1.8:1 ratio (approx.) of moles of sodium acetone bisulfite:equivalents of amine groups. The chitosan gradually dissolved over a period of 5-6 hours to yield a clear smooth-flowing solution.

### EXAMPLE 15

Chitosan Composition Range for Solubility of the Chitosan

The composition range for solubility of the chitosan using sodium formaldehyde bisulfite was studied using two ranges of chitosan. The first was prepared by heterogeneous deacetylation of shrimp chitin and covered the deacetylation range from 48.5% to 100%. The samples were slurried overnight in 50% water/50% ethanol containing 4 g sodium formaldehyde bisulfite/100 ml, filtered, rinsed in 50:50 water:ethanol, then stirred in distilled water for 4 hours to determine solubility. The solubility results are shown in Table 1:

TABLE 1

| % Deacetylation | Soluble |
|---|---|
| 100 | Yes |
| 84.8 | Yes |
| 76.2 | Yes |
| 73.7 | Yes |
| 70.9 | Yes |
| 67.8 | Yes |
| 59.6 | Yes |
| 55.2 | Yes—some gelled particles |
| 48.5 | No—particles only swollen |

These results suggest that 55% deacetylation is the lowest level of deacetylation that gives a soluble product with sodium formaldehyde bisulfite—alternatively 45% is the highest level of residual —NHCOCH₃ units that is acceptable in a heterogeneously prepared sample of chitosan if a soluble product is to be obtained on treatment with sodium formaldehyde bisulfite.

A second series was produced by homogeneous re-N-acetylation of a sample of chitosan previously deacetylated heterogeneously to 91.5% amine group (8.5% residual —NHCOCH₃ units). Samples were stirred overnight in an aqueous solution of sodium formaldehyde bisulfite (5% w/v) to determine solubility. The solubility results are shown in Table 2, in which the chitosan composition has been expressed as the percentage acetylation rather than the percentage deacetylation, in order to reflect the preparation route:

TABLE 2

| % N-Acetylation | Soluble |
|---|---|
| 8.5 | Yes |
| 18.1 | Yes |
| 31.4 | Yes |
| 33.0 | Yes |
| 47.7 | Yes |
| 55.3 | Yes |
| 58.3 | Yes |
| 66.0 | Yes |
| 69.5 | Yes |
| 73.4 | Yes—some gelled particles |
| 79.6 | No—particles only slightly swollen |

These results suggest that an N-acetylation level of 75% is the highest level of N-acetylation that is acceptable in a homogeneously prepared sample of chitosan if a soluble product is to be obtained on treatment with sodium formaldehyde bisulfite. It would be expected that samples prepared by homogeneous deacetylation of chitin would begin to show solubility on treatment with sodium formaldehyde bisulfite at about 25% deacetylation, compared to the 55% deacetylation requirement for a heterogeneously prepared sample.

1. A condensation product of chitosan and a bisulfite addition compound which has the formula HOCRR′SO₃A wherein:
each of R and R′ independently represents a hydrogen atom, or R represents a hydrogen atom and R′ represents an optionally substituted linear or branched saturated or unsaturated hydrocarbon group having up to 10 carbon atoms or an optionally substituted alicyclic, aromatic carbocyclic or heterocyclic ring, or R represents a CH₃ group and R′ represents an optionally substituted primary alkyl group, or R and R′ together represent an optionally substituted alicyclic or heterocyclic ring, and
A represents an alkali metal or ammonium ion,
which condensation product forms a stable anionic polyelectrolyte solution in water at neutral pH.

2. A condensation product according to claim 1 in which A represents a sodium ion.

3. A condensation product according to claim 1 or claim 2 in which R and R′ both represent hydrogen atoms.

4. A condensation product according to any preceding claim isolated as a solid.

5. A polymer comprising monomer units of formulae K, L, M and N: 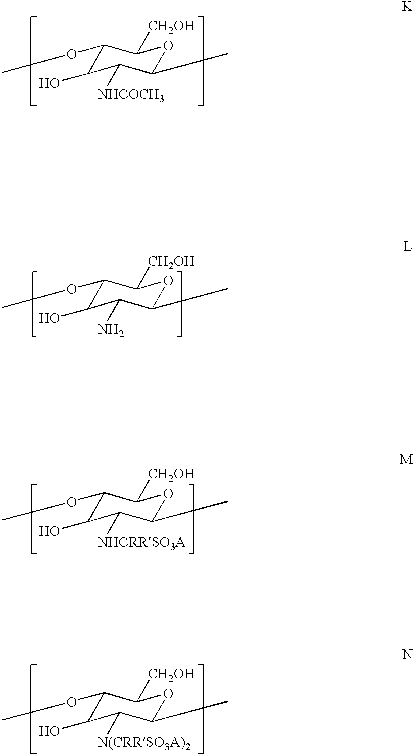
in the proportions k, l, m and n, respectively, wherein:
each of R and R′ independently represents a hydrogen atom, or R represents a hydrogen atom and R′ represents an optionally substituted linear or branched saturated or unsaturated hydrocarbon group having up to 10 carbon atoms or an optionally substituted alicyclic, aromatic carbocyclic or heterocyclic ring, or R represents a CH₃ group and R′ represents an optionally substituted primary alkyl group, or R and R′ together represent an optionally substituted alicyclic or heterocyclic ring, and
A represents an alkali metal cation or ammonium ion,
the proportions being such that the ratio:
$$\frac{m + 2 n}{k + l + m + n} \times 100 \% \geq 25 \%$$

6. A polymer according to claim 5 in which A represents a sodium ion.

7. A polymer according to claim 5 or claim 6 in which:
$$25 \% \leq \frac{m + n}{k + l + m + n} \times 100 \% \leq 100 \%$$

8. A polymer according to claim 7 in which:
$$65 \% \leq \frac{m + n}{k + l + m + n} \times 100 \% \leq 95 \%$$

9. A polymer according to any one of claims 5 to 8 in which:
$$\frac{k}{k + l + m + n} \times 100 \% \leq 75 \%$$

10. A polymer according to any one of claims 5 to 9 isolated as a solid.

11. An aqueous solution of a condensation product according to any one of claims 1 to 3.

12. An aqueous solution of a polymer according to any one of claims 5 to 9.

13. An aqueous solution according to any one of claims 10 to 12 further containing one or more other water soluble anionic polyelectrolytes.

14. An aqueous solution according to claim 13 in which the one or more other water soluble anionic polyelectrolytes are selected from sodium alginate, sodium carboxymethylcellulose, carragheenan, sodium cellulose sulfate, chondroitin sulfates, dermatan sulfate, heparan sulfate, heparin, hyaluronic acid, keratan sulfate, pectin, poly(sodium acrylate) and poly(sodium methacrylate).

15. An aqueous solution according to any one of claims 10 to 14 further containing one or more water soluble proteins.

16. An aqueous solution according to claim 15 in which the one or more water soluble proteins are selected from collagen and gelatine.

17. A film, fibre, powder, sponge, foam or gel prepared from a solution according to anyone of claims 10 to 16.

18. Chitosan regenerated from a condensation product according to any one of claims 1 to 4 by treating the condensation product with an acid or an alkali.

19. Chitosan regenerated from a polymer according to any one of claims 5 to 9 by treating the polymer with an acid or an alkali.

20. A film, fibre, powder, sponge, foam or gel according to claim 17 which has been treated with an acid or alkali to regenerate chitosan from the condensation product therein.

21. A film, fibre, powder, sponge, foam or gel according to claim 17 which has been treated with an acid or alkali to regenerate chitosan from the polymer therein.

22. A film, fibre, powder, sponge, foam or gel according to claim 20 or claim 21 in which the treatment was effected during the preparation of the film, fibre, powder, sponge, foam or gel.

23. A film, fibre, powder, sponge, foam or gel according to claim 20 or claim 21 in which the treatment was effected subsequent to the preparation of the film, fibre, powder, sponge, foam or gel.

24. A method for the preparation of a condensation product according to any one of claims 1 to 3, the method comprising slurrying chitosan with a solution of a bisulfite addition compound as defined in claim 1.

25. A method for the preparation of a condensation product according to any one of claims 1 to 3, the method comprising slurrying chitosan with a solution containing precursors of a bisulfite addition compound as defined in claim 1.

26. A method according to claim 25 in which the precursors are sodium metabisulfite (Na₂S₂O₅) and an aldehyde/ketone of the formula RR′CO wherein R and R′ are as defined in claim 1.

27. A method according to any one of claims 24 to 26 in which from 0.5 to 3.5 moles of the bisulfite addition compound are used per equivalent of chitosan amine groups.

28. A method according to any one of claims 24 to 26 in which from 1 to 2 moles of the bisulfite addition compound are used per equivalent of chitosan amine groups.

29. A method for the preparation of a condensation product according to claim 4, the method comprising admixing an aqueous solution according to claim 10 with a water miscible organic solvent, collecting the resultant precipitate and drying it.

30. A method for the preparation of a polymer blend, the method comprising the steps of:
blending an aqueous solution according to claim 11 or claim 12 with alginate in a weight ratio within the range of 5:1 to 1:5, and
treating the polymer blend so produced with an acid or alkali so as to regenerate chitosan or its salt.

31. A method for the extraction of chitosan from a chitin/calcium carbonate mixture, the method comprising deacetylating the said chitin/calcium carbonate mixture, slurrying the resultant chitosan/calcium carbonate mixture with a solution containing a bisulfite addition compound as defined in claim 1 or the precursors of such an addition compound, removing undissolved solids from the solution, treating the solution with acid or alkali to regenerate and precipitate chitosan, collecting the resultant precipitate and drying it.

32. A method for the preparation of a condensation product according to any one of claims 1 to 3 from a chitin/calcium carbonate mixture, the method comprising deacetylating the said chitin/calcium carbonate mixture, slurrying the resultant chitosan/calcium carbonate mixture with a solution containing a bisulfite addition compound as defined in claim 1 or the precursors of such an addition compound, removing undissolved solids from the solution, admixing the solution with a water miscible organic solvent, collecting the resultant precipitate and drying it.

33. A method for the preparation of a condensation product according to any one of claims 1 to 3 comprising:
re-acetylation of chitosan comprising monomer units of formulae K and L: 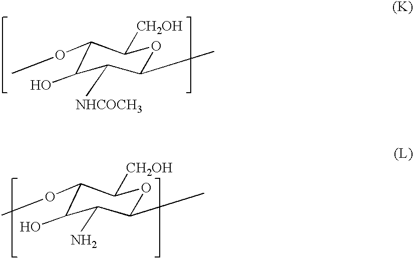
in the proportions k and l, respectively, to give material wherein k/(k+l) is less than or equal to 75%, and
reacting with a solution containing a bisulfite addition compound, or its precursors, as defined in any one of claims 1 to 3.
